(19) United States
(12) Patent Application Publication
(10) Pub. No.: US 2015/0328788 A1
(43) Pub. Date: Nov. 19, 2015

(54) HANDLE FOR SHAVER, AND SHAVER

(71) Applicant: Xiangrong Ren, Wenzhou (CN)

(72) Inventors: Xiangrong Ren, Wenzhou (CN); Chi REN, Wenzhou (CN)

(21) Appl. No.: 14/651,086

(22) PCT Filed: Dec. 11, 2012
(86) PCT No.: PCT/CN2012/086368

§ 371 Date: Jun. 10, 2015

(51) Int. Cl. B26B 21/52; B26B 21/14

(52) U.S. Cl. CPC B26B 21/521; B26B 21/14

(57) ABSTRACT

A handle for a shaver inserted into an interconnection structure (30) connected to a shaving head (20) includes a handle body (11) and cover body (12). The cover body (12) and the handle body (11) are mutually covered to form an inserting part (13) for inserting the interconnection structure (30), the inserting part (13) forms a decreasing slant structure along the inserting direction, the slant structure is inserted into the interconnection structure (30), the inserting part (13) includes a cover body inserting part (132) and a handle body inserting part (131), the cover body inserting part (132) is operably separated from the handle body inserting part (131) in a direction opposite to the direction in which the cover body (12) and the handle body (11) are covered together by pressing the handle body (11), and the separated cover body inserting part (132) and/or the handle body inserting part (131) eject(s) the interconnection structure (30) so that the shaving head (20) can fall off along with the interconnection structure (30).

### FIELD OF THE INVENTION

The present invention relates to a shaver apparatus and, more particularly to a handle for a shaver and a shaver with the same.

### BACKGROUND OF THE INVENTION

With improvement of the economy and the society, abounding consumables are offered to people to satisfy people's demand, thereby improving people's standard or living. While shavers are one of these consumables.

Currently, the shavers have two types including electric shavers and manual shavers. Regarding the manual shavers, the beards is cut by a shaving head driven by the user, so as to actualize the action of shaving, so manual shavers with respect to electric shavers are more environmentally friendly, and the market share is growing.

Wherein the manual shaver includes a handle, a shaving head and a interconnection structure connected between the handle and the shaving head, and an engaging structure adapted for engaging the handle with the interconnection structure and a disengaging structure adapted for disengaging the handle with the interconnection structure are provided between the handle and the interconnection structure. When the shaving head need to be removed from the handle, firstly pressing the disengaging structure with one hand to urge the engaging structure, so as to disengage the handle with the interconnection structure; the disengaging structure need being pressed until the shaving head is pulled with the other hand to separate the handle from the interconnection structure, thereby to realize an effect that the shaving head can fall off along with the interconnection structure. Therefore, the user can not separate the handle and the interconnection structure with one hand so that the shaving head can fall off automatically along with the interconnection structure.

Thus, there is a need for a handle for a shaver and a shaver with the same to overcome the above-mentioned drawbacks.

### SUMMARY OF THE INVENTION

One objective of the present invention is to provide a handle for a shaver thereby separating the handle and an interconnection structure with one hand so that a shaving head can fall off automatically along with the interconnection structure.

Another objective of the present invention is to provide a shaver thereby separating a handle and a interconnection structure with one hand so that a shaving head can fall off automatically along with the interconnection structure.

To achieve the above-mentioned objectives, a handle for a shaver, adapted for inserting into an interconnection structure connected to a shaving head of the shaver, includes a handle body and a cover body, wherein the cover body and the handle body are mutually covered to form an inserting part for inserting into the interconnection structure, the inserting part forms a decreasing slant structure along the inserting direction, the slant structure is inserted into the interconnection structure, the inserting part includes a cover body inserting part and a handle body inserting part, the cover body inserting part is operably separated from the handle body inserting part in a direction opposite to the direction in which the cover body and the handle body are covered together by pressing the handle body, and the separated cover body inserting part and/or the cover body inserting part eject(s) the interconnection structure so that the shaving head can fall off along with the interconnection structure.

The shaver of the present invention includes a handle, a shaving head and an interconnection structure connected between the handle and the shaving head, the handle is engaged with the interconnection structure, and an operating member is configured on the handle for disengaging the handle with the interconnection structure, wherein the handle includes a handle body and a cover body, the cover body and the handle body are mutually covered to form an inserting part for inserting into the interconnection structure, the inserting part forms a decreasing slant structure along the inserting direction, the slant structure is inserted into the interconnection structure, the inserting part comprises a cover body inserting part and a handle body inserting part, the cover body inserting part is operably separated from the handle body inserting part in a direction opposite to the direction in which the cover body and the handle body are covered together; by pressing the operating member the handle is urged to be disengaged with the interconnection structure, and the handle body inserting part is separated from the cover body inserting part, and the separated cover body inserting part and/or the cover body inserting part eject(s) the interconnection structure so that the shaving head can fall off along with the interconnection structure.

Preferably, the cover body and the handle body are fixedly covered together, and a space is formed between the cover body inserting part and the handle body inserting part, the cover body inserting part and the handle body inserting part are pushed to draw close to each other by the interconnection structure when the inserting part is inserted into the interconnection structure and the handle engages with the interconnection structure, and the cover body inserting part and the handle body inserting part splay apart when the handle is disengaged with the interconnection structure.

Preferably, the cover body is operably separated from the handle body in a direction opposite to the direction in which the cover body and the handle body are covered together; the operating member urges the handle to be disengaged with interconnection structure as well as urges the handle body inserting part to be separated from the cover body inserting part.

Preferably, the interconnection structure has a hollow structure, which forms an inserting cavity matching with the slant structure.

Preferably, the shaver of the present invention further includes an engaging member for engaging the handle with the interconnection structure, the engaging member comprises a mounting portion mounted on the handle body and two impending engaging portions extending from both sides of the mounting portion toward the interconnection structure, a barb is formed on each engaging portion, and an engaging block extends from the interconnection structure inward the inserting cavity for engaging with the barb, the operating member is slidably configured on the mounting portion and urges the engaging portion to be disengaged with the engaging block.

Preferably, each engaging portion has a ramp elongated slot therein, two ramp elongated slot is disposed in a splay shape, the operating member has a pushing column inserted in the ramp elongated slot with a fitting clearance; pressing the operating member to urge the two engaging portions to move along a direction of drawing close to each other by the pushing column thereon, thereby to disengage the engaging portion with the engaging block.

Preferably, a first cover portion is formed on the handle body, and a second cover portion is formed on the cover body for engaging with the first cover portion.

Preferably, one of the first cover portion and the second cover portion has a projection, the other one of the first cover portion and the second cover portion has a groove.

Preferably, several inserting columns are formed on one of the handle body and the cover body and arranged in a plane, and several inserting holes are accordingly opened in the other one of the handle body and the cover body.

In comparison with the prior art, since the cover body and the handle body are mutually covered to form an inserting part for inserting into the interconnection structure, the inserting part forms a decreasing slant structure along the inserting direction, the slant structure is inserted into the interconnection structure, the inserting part comprises a cover body inserting part and a handle body inserting part, the cover body inserting part is operably separated from the handle body inserting part in a direction opposite to the direction in which the cover body and the handle body are covered together; so by pressing the operating member the handle is urged to be disengaged with the interconnection structure, and the handle body inserting part is separated from the cover body inserting part, and the separated cover body inserting part and/or the handle body inserting part eject(s) the interconnection structure with the help of the slant structure thereof and provides the interconnection structure with a pushing force along a direction of being ejected from the inserting part, the pushing force keeps pushing the interconnection structure during the process that the cover body inserting part is separated from the handle body inserting part, so as to let the shaving head fall off along with the interconnection structure and realize an effect that the shaving head can fall off automatically along with the interconnection structure with one hand operation. Therefore, the shaver of the present invention realizes an effect that the shaving head along with the interconnection structure can fall off automatically from the handle with one hand operation, and has advantages of simplifying operation and simple structure.

### BRIEF DESCRIPTION OF THE DRAWINGS

The accompanying drawings facilitate an understanding of the various embodiments of this invention. In such drawings:

FIG. 1 is a perspective view of a shaver of the present invention;

FIG. 2 is an exploded view of the shaver shown in FIG. 1;

FIG. 3 is a perspective view of a shaver without a shaving head, a interconnection structure and cover body of the present invention;

FIG. 4 is an exploded view of FIG. 3;

FIG. 5 is a perspective view of an assembly of a shaving head and a interconnection structure of a shaver of the present invention;

FIG. 6a and FIG. 6b are flow charts illustrating a shaving head along with an interconnection structure fall off automatically from a handle with one hand operation.

### DETAILED DESCRIPTION OF ILLUSTRATED EMBODIMENTS

A distinct and full description of the technical solution of the present invention will follow by combining with the accompanying drawings. By all appearances, the embodiments to be described just are a part of embodiments of the present invention, not the all. Based on the embodiment of the present invention, all other embodiments obtained by the person ordinarily skilled in the art without any creative work pertain to the protection scope of the present invention.

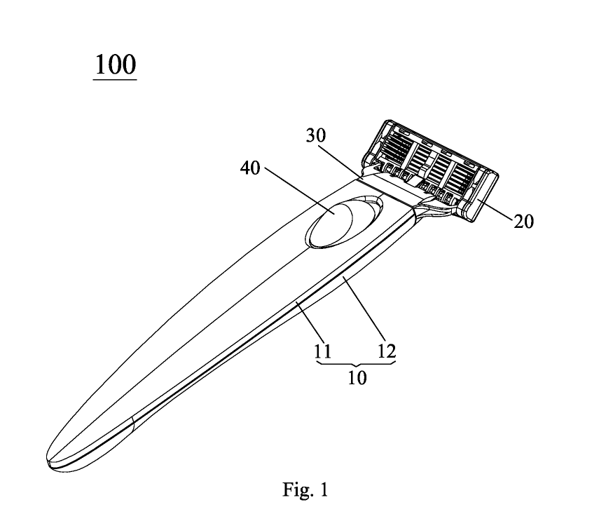

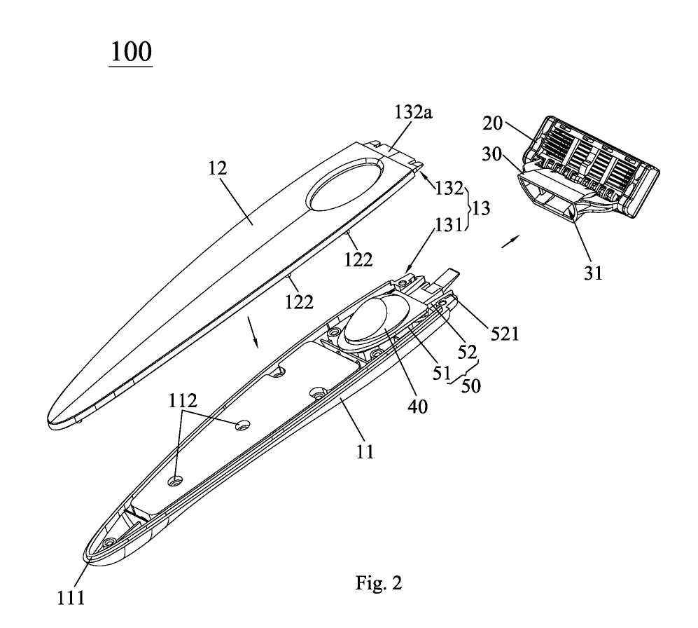

Referring to FIG. 1 and FIG. 2, the shaver 100 of the present invention includes a handle 10, a shaving head 20 and a interconnection structure 30 connected between the handle 10 and the shaving head 20, the handle 10 is engaged with the interconnection structure 30, and an operating member 40 is configured on the handle 10 for disengaging the handle 10 with the interconnection structure 30. Concretely, in this embodiment, a button is preferred as one of the operating member 40 so as to simplify the structure of the operating member 40, and the operating member 40 is preferably disposed on a handle body 11 mentioned below so as to simplify the structure of the handle 10; and the shaving head 20 is pivotally connected to the interconnection structure 30, thereby the shaving head 20 can rotate with respect to the interconnect structure 30 to better meet the requirements of shaving.

The handle 10 includes a handle body 11 and a cover body 12, the cover body 12 and the handle body 11 are mutually covered to form an inserting part 13 for inserting into the interconnection structure 30, the inserting part 13 forms a decreasing slant structure along the inserting direction (namely the arrow direction near the interconnection structure 30 in FIG. 2), preferably forms a gradually decreasing slant structure, the slant structure is inserted into the interconnection structure 30. The inserting part 13 includes a cover body inserting part 132 and a handle body inserting part 131, the cover body inserting part 132 is operably separated from the handle body inserting part 131 in a direction opposite to the direction in which the cover body 12 and the handle body 11 are covered together (namely a direction opposite to the arrow direction near the cover body 12 in FIG. 2). By pressing the operating member 40 the handle 10 is urged to be disengaged with the interconnection structure 30, and the handle body inserting part 131 is separated from the cover body inserting part 132, and the separated cover body inserting part 132 and/or the handle body inserting part 131 eject(s) the interconnection structure 30 so that the shaving head 20 can fall off along with the interconnection structure 30; concretely, in this embodiment, the interconnection structure 30 is ejected out by the cover body inserting part 132 to simplify the structure of the handle, of course, in other embodiment, the interconnection structure 30 can be ejected out by the handle body inserting part 131 only or by the cover body inserting part 132 together with the handle body inserting part 131. In the present embodiment, the method of separating the cover body inserting part 132 from the handle body inserting part 131 is: the cover body 12 is operably separated from the handle body 11 in a direction opposite to the direction in which the cover body 12 and the handle body 11 are covered together; by pressing the operating member 40 the handle 10 is urged to be disengaged with interconnection structure 30, in the meantime, the handle body inserting part 131 is urged to be disengaged with the cover body inserting part 132, thereby to realize a method for separating the cover body inserting part 132 from the handle body inserting part 131. Of course, in other embodiment, the method of separating the cover body inserting part 132 from the handle body inserting part 131 is: the cover body 12 and the handle body 11 are fixedly covered together, and a space is formed between the cover body inserting part 132 and the handle body inserting part 131 (i.e., the cross-sectional area of the inserting part 13 along a direction perpendicular to the inserting direction is larger than that of the corresponding inner wall of the inserting cavity 31 of the interconnection structure 30 mentioned below when the inserting part 13 is not inserted into the interconnection structure 30); the cover body inserting part 132 and the handle body inserting part 131 are pushed to draw close to each other and pressed by the interconnection structure 30 when the inserting part 13 is inserted into the interconnection structure 30 and the handle 10 engages with the interconnection structure 30; the cover body inserting part 132 and the handle body inserting part 131 splay apart when the handle 10 is disengaged with the interconnection structure 30, thereby another method of separating the cover body inserting part 132 from the handle body inserting part 131 is provided. Wherein, one surface of the cover body inserting part 132 facing the interconnection structure 30 is an angular surface 132a so as to push the interconnection structure 30 out more reliably. More concretely, as follow:

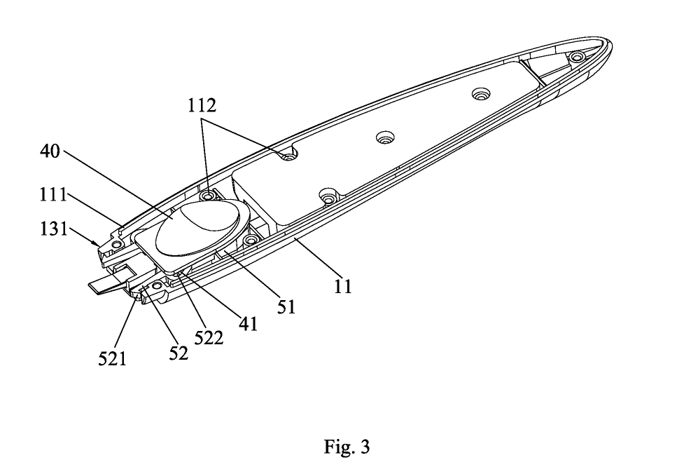

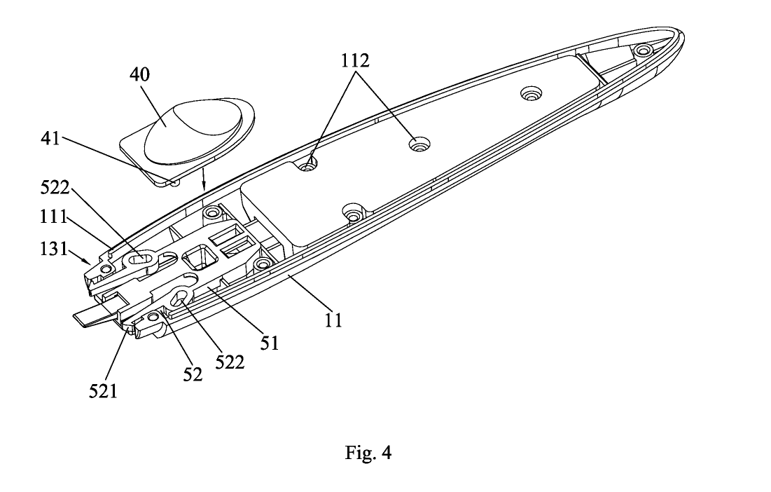

Referring to FIG. 3 and FIG. 4, a preferable method of covering the handle body 11 and the cover body 12 with each other is: a first cover portion 111 is formed on the handle body 11, and a second cover portion (not shown in Figs) is formed on the cover body 12 for engaging with the first cover portion 111, thereby the handle body 11 and the cover body 12 are mutually covered more easily without affecting separating the cover body 12 from the handle body 11; concretely, the first cover portion 111 is configured on the edge of the handle body 11 and corresponds to the edge of the handle body 11 (i.e. the shape of the first cover portion 111 corresponds to that of the edge of the handle body 11) to facilitate manufacturing of the first cover portion 111. Preferably, in this embodiment, the first cover portion 111 has a projection, and the second cover portion has a groove, thereby to simplify the structure of the first cover portion 111 and the second cover portion; of course, in other embodiment, the first cover portion 111 can have a groove, while the second cover portion accordingly can have a projection, that is to say, the ordinary skill in this art can select flexibly according to actual needs.

For covering and separating the handle body 11 and the cover body 12 more reliably, several inserting columns 122 are formed on one of the handle body 11 and the cover body 12 and arranged in a plane, and several inserting holes 112 are accordingly opened in the other one of the handle body 11 and the cover body 12. Concretely, in this embodiment, the inserting columns 122 is configured on the cover body 12, the inserting holes are opened in the handle body 11, thereby to decrease the thickness of the cover body 11 and make the structure of the handle 10 composed of the handle body 11 and the cover body 12 more compact and reasonable. Preferably, the inserting columns 122 are located within the second cover portion and surrounded by the second cover portion, accordingly, the inserting holes 112 are located within the first cover portion 111 and surrounded by the first cover portion 111, thereby the reliability of separating the cover body 12 from the handle body 11 is further improved. Of course, in other embodiment, the inserting columns 122 can be formed on the handle body 11, and the inserting holes are accordingly opened in the cover body 12, that is to say, the ordinary skill in this art can select flexibly according to actual needs.

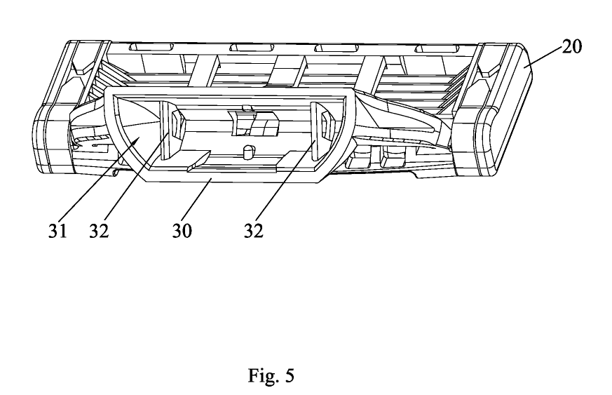

Referring to FIG. 3 to FIG. 5, the interconnection structure 30 mentioned above has a hollow structure, which forms an inserting cavity 31 matching with the slant structure, so as to insert the inserting part 13 into the interconnection structure 30; concretely, in this embodiment, the shaver 100 of the present invention further includes an engaging member 50 for engaging the handle 10 with the interconnection structure 30, the engaging member 50 includes a mounting portion 51 mounted on the handle body 11 and two impending engaging portions 52 extending from both sides of the mounting portion 51 (the front and rear sides of the mounting portion 51 as shown in FIG. 3) toward the interconnection structure 30, a barb 521 is formed on each engaging portion 52, and an engaging block 32 extends from the interconnection structure 30 inward the inserting cavity 31 for engaging with the barb 521, preferably, the engaging block 32 is configured vertically in the inserting cavity 31 and fixedly connected to the inner wall of the inserting cavity 31 with two ends thereof, a side of the two barbs 521 used for engaging with the engaging block 32 is configured in a splay shape along a direction in which the inserting part 13 is inserted into the interconnection structure 30, thereby to improve the reliability of engagement between the barb 521 and the engaging block 32 so as to ensure the reliability of the engaging block 32. The operating member 40 is slidably configured on the mounting portion 51, by pressing the operating member 40 the engaging portion 52 is urged to be disengaged with the engaging block 32, so as to disengage the interconnection structure 30 with the handle 10 and simplify the engaging structure configured between the handle 10 and the interconnection structure 30. Preferably, the barb 521 is formed at the end of the engaging portion 52 to facilitate engaging action of the barb 521 and the engaging block 32. More specifically, each engaging portion 52 has a ramp elongated slot 522 therein, two ramp elongated slot 522 is disposed in a splay shape, and the operating member 40 has a pushing column 41 inserted in the ramp elongated slot 522 with a fitting clearance; pressing the operating member 40 to urge the two engaging portions 52 to move along a direction of drawing close to each other by the pushing column 41 thereon, thereby to disengage the engaging portion 52 with the engaging block 32, and thus simplify the disengaging structure that the operating member 40 urges the engaging portion 52 to be disengaged with the engaging block 32.

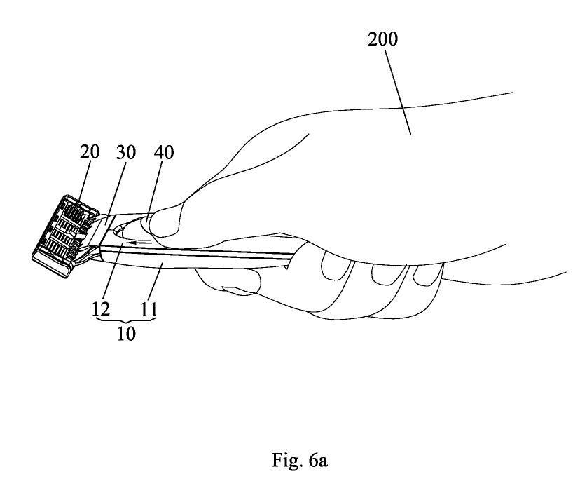

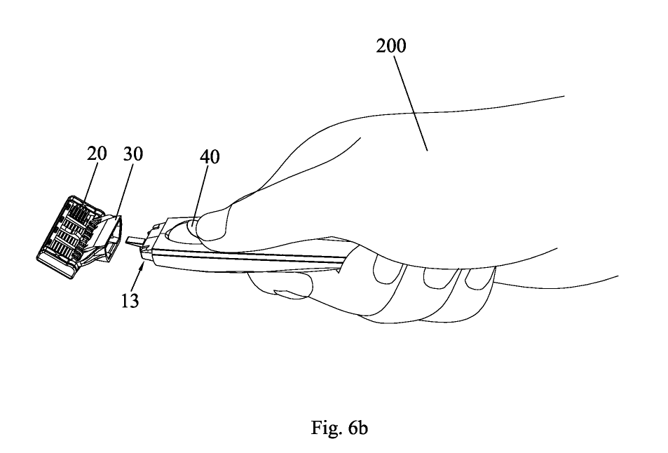

Referring to FIG. 6a and FIG. 6b, the operating principle of making the shaving head 20 to fall off automatically along with the interconnection structure 30 with one hand operation will be described below: when the shaving head 20 need to fall off automatically along with the interconnection structure 30 from the handle 10, four fingers of one hand 200 grips the handle 10 of the shaver 100 as well as the thumb of the hand 200 presses the operating member 40 of the shaver 100 to slide the operating member 40 in a direction indicated by an arrow on the handle 10 shown in FIG. 6a, the sliding operating member 40 can urge the two engaging portion 52 to move along a direction of drawing close to each other, thereby to disengage the engaging portion 52 configured between the handle 10 and the interconnection structure 30 as the pushing column 41 of the operating member 40 matches with the ramp elongated slot 522 of the engaging member 50. Meanwhile, the operating member 40 pushes the handle body 11 of the handle 10 as it is sliding, thereby to separate the handle body inserting part 131 from the cover body inserting part 132, and the separated cover body inserting part 132 pushes the interconnection structure 30 with the help of the slant structure thereof and provides the interconnection structure 30 with a pushing force along a direction of being separated from the inserting part 13, the pushing force keeps pushing the interconnection structure 30 during the process that the cover body inserting part 132 is separated from the handle body inserting part 131, so as to let the shaving head 20 fall off along with the interconnection structure 30 and realize an effect that the shaving head 20 can fall off automatically along with the interconnection structure 30 with one hand operation, as shown in FIG. 6b.

In comparison with the prior art, since the cover body 12 and the handle body 11 are mutually covered to form an inserting part 13 for inserting into the interconnection structure 30, the inserting part 13 forms a decreasing slant structure along the inserting direction, the slant structure is inserted into the interconnection structure 30, the inserting part 13 comprises a cover body inserting part 132 and a handle body inserting part 131, the cover body inserting part 132 is operably separated from the handle body inserting part 131 in a direction opposite to the direction in which the cover body 12 and the handle body 11 are covered together; so by pressing the operating member 40 the handle 10 is urged to be disengaged with the interconnection structure 30, and the handle body inserting part 131 is separated from the cover body inserting part 132, and the separated cover body inserting part 132 and/or the handle body inserting part 131 eject(s) the interconnection structure 30 with the help of the slant structure thereof and provides the interconnection structure 30 with a pushing force along a direction of being separated from the inserting part 13, the pushing force keeps pushing the interconnection structure 30 during the process that the cover body inserting part 132 is separated from the handle body inserting part 131, so as to let the shaving head 20 fall off along with the interconnection structure 30 and realize an effect that the shaving head 20 can fall off automatically along with the interconnection structure 30 with one hand operation. Therefore, the shaver 100 of the present invention can realize an effect that the shaving head 20 along with the interconnection structure 30 can fall off automatically from the handle 10 with one hand operation, and has advantages of simplifying operation and simple structure.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A handle for a shaver, adapted for inserting into an interconnection structure connected to a shaving head of the shaver, comprising a handle body and a cover body, wherein the cover body and the handle body are mutually covered to form an inserting part for inserting into the interconnection structure, the inserting part forms a decreasing slant structure along an inserting direction, the slant structure is inserted into the interconnection structure, the inserting part comprises a cover body inserting part and a handle body inserting part, the cover body inserting part is operably separated from the handle body inserting part in a direction opposite to the direction in which the cover body and the handle body are covered together by pressing the handle body, and the separated cover body inserting part and/or the handle body inserting part eject(s) the interconnection structure so that the shaving head can fall off along with the interconnection structure.

2. A shaver, comprising a handle, a shaving head and an interconnection structure connected between the handle and the shaving head, the handle being engaged with the interconnection structure, and an operating member being configured on the handle for disengaging the handle with the interconnection structure, wherein the handle comprises a handle body and a cover body, the cover body and the handle body are mutually covered to form an inserting part for inserting into the interconnection structure, the inserting part forms a decreasing slant structure along the inserting direction, the slant structure is inserted into the interconnection structure, the inserting part comprises a cover body inserting part and a handle body inserting part, the cover body inserting part is operably separated from the handle body inserting part in a direction opposite to the direction in which the cover body and the handle body are covered together; by pressing the operating member the handle is urged to be disengaged with the interconnection structure, and the handle body inserting part is separated from the cover body inserting part, and the separated cover body inserting part and/or the handle body inserting part eject(s) the interconnection structure so that the shaving head can fall off along with the interconnection structure.

3. The shaver according to claim 2, wherein the cover body and the handle body are fixedly covered together, and a space is formed between the cover body inserting part and the handle body inserting part, the cover body inserting part and the handle body inserting part are pushed to draw close to each other by the interconnection structure when the inserting part is inserted into the interconnection structure and the handle engages with the interconnection structure, and the cover body inserting part and the handle body inserting part splay apart when the handle is disengaged with the interconnection structure.

4. The shaver according to claim 2, wherein the cover body is operably separated from the handle body in a direction opposite to the direction in which the cover body and the handle body are covered together; the operating member urges the handle to be disengaged with interconnection structure as well as urges the handle body inserting part to be separated from the cover body inserting part.

5. The shaver according to claim 2, wherein the interconnection structure has a hollow structure, which forms an inserting cavity matching with the slant structure.

6. The shaver according to claim 5, wherein further comprises an engaging member for engaging the handle with the interconnection structure, the engaging member comprises a mounting portion mounted on the handle body and two impending engaging portions extending from both sides of the mounting portion toward the interconnection structure, a barb is formed on each engaging portion, and an engaging block extends from the interconnection structure inward the inserting cavity for engaging with the barb, the operating member is slidably configured on the mounting portion and urges the engaging portion to be disengaged with the engaging block.

7. The shaver according to claim 6, wherein each engaging portion has a ramp elongated slot therein, two ramp elongated slot is disposed in a splay shape, the operating member has a pushing column inserted in the ramp elongated slot with a fitting clearance; pressing the operating member to urge the two engaging portions to move along a direction of drawing close to each other by the pushing column thereon, thereby to disengage the engaging portion with the engaging block.

8. The shaver according to claim 2, wherein a first cover portion is formed on the handle body, and a second cover portion is formed on the cover body for engaging with the first cover portion.

9. The shaver according to claim 8, wherein one of the first cover portion and the second cover portion has a projection, the other one of the first cover portion and the second cover portion has a groove.

10. The shaver according to claim 2, wherein several inserting columns are formed on one of the handle body and the cover body and arranged in a plane, and several inserting holes are accordingly opened in the other one of the handle body and the cover body.
